(19) United States
(12) Patent Application Publication
(10) Pub. No.: US 2006/0001766 A1
(43) Pub. Date: Jan. 5, 2006

(54) Digital multimedia playing and recording storage device with a function of a digital camera

(76) Inventor: Juen Tien Peng, Chung Li (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/880,578

(22) Filed: Jul. 1, 2004

(51) Int. Cl. H04N 5/225; H04N 5/232; H04M 1/00

(52) U.S. Cl. 348/373; 348/211.2; 455/556.1

(57) ABSTRACT

A digital multimedia playing and recording storage device with a function of a digital camera, includes a CPU, an HD for storing data processed by the CPU, an I/O module connected with the CPU for transmitting data from the CPU, a video capturing module connected with the CPU for capturing video data, a function key module for selectively controlling function status of the CPU, an LCD driving module for displaying video data processed by the CPU, an audio module connected with the CPU for capturing or playing audio data, and a power supply module for supplying power to the above modules.

### BACKGROUND OF THE INVENTION

1. Field of the Invention

The present invention relates to a storage device, and particularly to a digital multimedia playing and recording storage device with a function of a digital camera.

2. Prior Art

As development of information technology, people may take with more and more digital products. For example, an office worker may take with a portable data storage disk, a digital camera, a recording pen, a multimedia player and so on. Each kind of digital products provides a specific function.

However, it is often inconvenient for a user to take with many digital products for providing different functions. For example, as a popular digital product, a digital camera is assembled with a memory card for storing data of pictures. Capacity of a conventional memory card is usually 128 MB or 256 MB which can only store a few of pictures. Therefore, a user has to take with several memory cards for a larger capacity. However, the memory card is quite expensive. Furthermore, different kinds of memory cards, such as a compact flash (CF) card, a smart media (SM) card, a memory stick (MS) card and so on, are incompatible.

Thus, it is required to design a digital multifunctional product which is bulky in capacity, portable and plugable and play.

### SUMMARY OF THE INVENTION

Accordingly, an object of the present invention is to provide a digital multimedia playing and recording storage device with a function of a digital camera, which is bulky in capacity and provides functions of a digital camera, a multimedia player and a recording pen for convenience to use.

Another object of the present invention is to provide a digital multimedia playing and recording storage device with a function of a digital camera for being portable.

Another object of the present invention is to provide a digital multimedia playing and recording storage device with a function of a digital camera, which is combined with a digital camera, a multimedia player, a USB interface, and a wireless transmission module, and which uses a hard disk (HD) as a storage module for storing data from the digital camera or the multimedia player or through the USB interface or the wireless transmission module, thereby providing a small, light and portable storage device with high capacity.

Another object of the present invention is to provide a digital multimedia playing and recording storage device with a function of a digital camera having a USB interface for providing a function of plug and play.

To achieve the above-mentioned objects, a digital multimedia playing and recording storage device with a function of a digital camera in accordance with the present invention includes a CPU, an HD for storing data processed by the CPU, an I/O module connected with the CPU for transmitting data from the CPU, a video capturing module connected with the CPU for capturing video data, a function key module for selectively controlling function status of the CPU, an LCD driving module for displaying video data processed by the CPU, an audio module connected with the CPU for capturing or playing audio data, and a power supply module for supplying power to the above modules.

Other objects, advantages and novel features of the present invention will be drawn from the following detailed embodiment of the present invention with attached drawings, in which:

### BRIEF DESCRIPTION OF THE DRAWINGS

FIG. 1 is a schematic chart showing a digital multimedia playing and recording storage device with a function of a digital camera of the present invention.

### DESCRIPTION OF THE PREFERRED EMBODIMENT

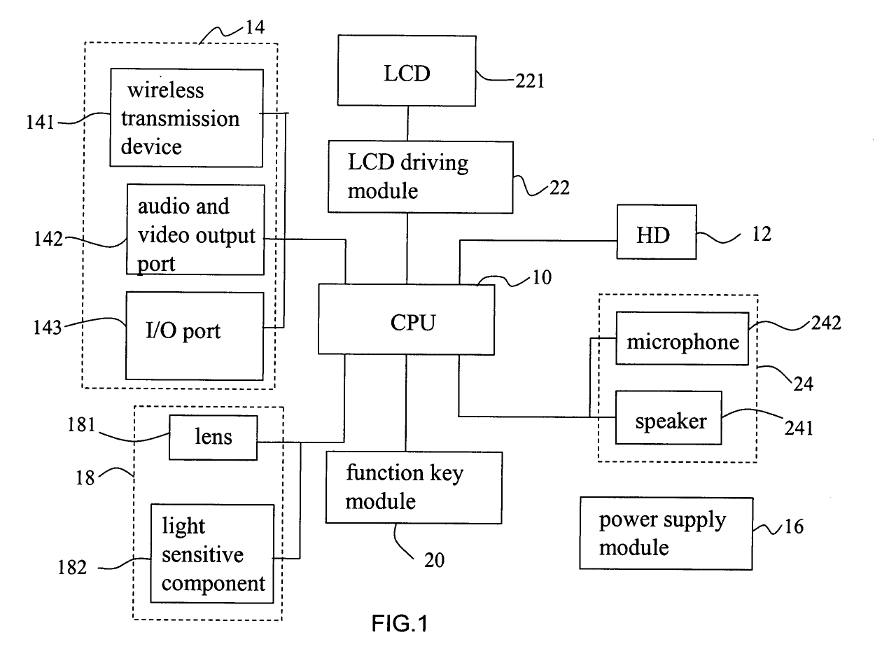

Referring to FIG. 1, a digital multimedia playing and recording storage device with a function of a digital camera of the present invention includes a central processing unit (CPU) 10, a hard disk (HD) 12 for storing data processed by the CPU 10, an input/output (I/O) module 14 connected with the CPU 10 for transmitting the data of the CPU 10, a power supply module 16, a video capturing module 18 connected with the CPU 10 for capturing video data, a function key module 20 for selectively controlling function status of the CPU 10, a liquid crystal display (LCD) driving module 22 for displaying video data processed by the CPU 10, and an audio module 24 connected with the CPU 10. The power supply module 16 supplies power to the above modules. The video capturing module 18 includes a lens 181 and a light sensitive component 182. The audio module 24 includes a speaker 241 for audio output and a microphone 242 for audio input.

The I/O module 14 is used for transmitting video data or other data and includes a wireless transmission device 141 for wireless transmission, an audio and video (AV) output port 142, and an I/O port 143 which may be a USB interface for providing a function of plug and play. The wireless transmission device 141 may be a Bluetooth data transmission device or an infrared data transmission device. The I/O port 143 may be connected with a personal computer, an AV player and so on. The CPU 10 may transmit data through the I/O port 143.

In use of the digital multimedia playing and recording storage device of the present invention, one of functions of the digital multimedia playing and recording storage device may be selected through the function key module 20. For example, when the AV recording function is selected, the CPU 10 can receive video data captured by the lens 181 and the light sensitive component 182 of the video capturing module 18 and audio data input by the microphone 241 of the audio module 24. Then the CPU 10 compresses the received AV data and converts the received AV data to MPEG format with high compression ratio and high quality and then stores the AV data in the HD 12.

Of cause, the CPU 10 may be configured to only receive the video data from the video capturing module 18 for achieving a video recording function, or to only receive the audio data from the microphone 241 for achieving an audio recording function.

After the CPU 10 stores the AV data in the HD 12, a video playing function may be selected through the function key module 20 to turn on an LCD 221 of the LCD driving module 22 and the speaker 242 of the audio module 24 thereby playing the AV data. Of cause, AV data prestored in the HD 12 can also be played by the CPU 10 through the LCD 221 of the LCD driving module 22 and the speaker 242.

Of cause, audio data, such as MP3, stored in the HD 12 may be read by the CPU 10 and then played through the speaker 242 of the audio module 24 thereby achieving a function of a music player.

Selection of the above functions of the present invention is made through the function key module 20 to control the CPU 10. For example, a video recording function to receive video data captured by the video capturing module 18, or an audio recording or playing function to receive audio data from the microphone 241 or play audio data through the speaker 242, or an AV recording function to receive video data from the video capturing module 18 and audio data from the microphone 241 of the audio module 24, or a multimedia playing function to drive the LCD driving module 22, or a function of a portable data storage device to transmit data through the I/O port 143 or the wireless transmission device 141, may be selected respectively. The HD 12 is a mini HD with high capacity and so the digital multimedia playing and recording storage device of the present invention can store quite a lot of AV data.

As mentioned above, the digital multimedia playing and recording storage device with a function of a digital camera of the present invention has functions of a digital camera, a multimedia player, a portable data storage device, a recording pen and a USB interface, and uses the HD 12 with high capacity to store data captured by the digital camera, the multimedia player, the recording pen, or transmitted from external devices through the USB interface. Thus, the digital multimedia playing and recording storage device with a function of a digital camera of the present invention is small, light and bulky in capacity and so is convenient to use.

It is understood that the invention may be embodied in other forms without departing from the spirit thereof. Thus, the present examples and embodiments are to be considered in all respects as illustrative and not restrictive, and the invention is not to be limited to the details given herein.

1. A digital multimedia playing and recording storage device with a function of a digital camera, comprising:
a CPU;
an HD, for storing data processed by the CPU;
an I/O module, connected with the CPU for transmitting data from the CPU;
a video capturing module, connected with the CPU for capturing video data;
a function key module, for selectively controlling function status of the CPU;
an LCD driving module, for displaying video data processed by the CPU;
an audio module, connected with the CPU for capturing or playing audio data; and
a power supply module, for supplying power to the above modules.

2. The digital multimedia playing and recording storage device with a function of a digital camera as claimed in claim 1, wherein the video capturing module includes a lens and a light sensitive component.

3. The digital multimedia playing and recording storage device with a function of a digital camera as claimed in claim 1, wherein the I/O module includes an I/O port, a wireless transmission device and an AV output port.

4. The digital multimedia playing and recording storage device with a function of a digital camera as claimed in claim 3, wherein the I/O port is connectable with a personal computer, an AV player and so on.

5. The digital multimedia playing and recording storage device with a function of a digital camera as claimed in claim 3, wherein the I/O port is a USB interface.

6. The digital multimedia playing and recording storage device with a function of a digital camera as claimed in claim 1, wherein the audio module includes a speaker and a microphone.

7. The digital multimedia playing and recording storage device with a function of a digital camera as claimed in claim 1, wherein the CPU can compress and convert video data captured by the video capturing module and audio data captured by the audio module to MPEG format with high compression ratio and high quality.
